(19) United States
(12) Patent Application Publication
(10) Pub. No.: US 2013/0050159 A1
(43) Pub. Date: Feb. 28, 2013

(54) GATE DRIVER AND DISPLAY DEVICE THEREWITH

(71) Applicant: Chun-Fu Wang, Hsinchu County (TW)

(72) Inventor: Chun-Fu Wang, Hsinchu County (TW)

(73) Assignee: ORISE TECHNOLOGY CO., LTD., Hsinchu City (TW)

(21) Appl. No.: 13/517,614

(22) Filed: Jun. 14, 2012

(30) Foreign Application Priority Data
Aug. 25, 2011 (CN) 201110251291.8

(51) Int. Cl. G06F 3/038

(52) U.S. Cl. 345/204

(57) ABSTRACT

A gate driver and a display device are disclosed. The gate driver includes an image data receiving interface, an image processing unit, a timing controller, and a gate driving unit. The image data receiving interface receives an input signal and transfers the same to a display image signal and a display control signal. The image processing unit receives the display image signal and transfers the same to a display data. The timing controller transfers the display control signal into a first and second control signals. The first control signal and the display data are output to a source driver. The gate driving unit receives the second control signal to drive gate scanning lines accordingly, and the gate driving unit sequentially drives the gate scanning lines according to the second control signal. The source driver supplies the display data to pixels according to the first control signal.

### CROSS-REFERENCE TO RELATED APPLICATION

This application claims the priority benefit of China application serial no. 201110251291.8, filed on Aug. 25, 2011. The entirety of the above-mentioned patent application is hereby incorporated by reference herein and made a part of this specification.

### BACKGROUND OF THE INVENTION

1. Field of the Invention

The invention relates to a driving circuit. Particularly, the invention relates to a gate driver having a timing control function and a display device using the same.

2. Description of Related Art

A conventional display device generally includes a driving circuit for driving a display panel to display. FIG. 1A is a schematic diagram of a conventional display device. The display device 100 at least includes a display panel 110, a source driver 120, a gate driver 130 and a timing controller 140.

The timing controller 140 receives display image data and synchronous signals through a signal 102, and transfers the display image data into a data format that can be accepted by an output interface, and outputs the same to the source driver 120. Moreover, the timing controller 140 further generates control signals required by the source driver 120 and the gate driver 130. Namely, the timing controller 140 sends controls signals to a latch circuit 150, the source driver 120, the gate driver 130 and a gray-level voltage generating circuit 160 in timing, for example, image data is read from an image data memory and transmitted to the latch circuit 150. The timing controller 140 controls the source driver 120 (with a plurality of source data lines 122₁, 122₂, . . . , 122₃ₙ) and the gate driver 130 (with a plurality of gate scan lines 132₁, 132₂, . . . , 132ₘ) to transmit the image data to corresponding pixels in the display panel 110 through source data lines 122 and gate scan lines 132, so as to display a corresponding image.

FIG. 1B is a schematic diagram illustrating a connection structure of the display panel 110, the source driver 120, the gate driver 130 and the timing controller 140 of the display device of FIG. 1A. The display panel 110 includes a plurality of pixels 112 arranged in an array, and each of the pixels 112 includes display spots of three primary colors of red (R), green (G) and blue (B), which are respectively corresponded to a source data line 122 of the source driver 120 and a gate scan line 132, and are driven by the source driver 120 and the gate driver 130 to display.

The timing controller 140 controls the source driver 120 and the gate driver 130, and controls the pixels 112 through the gate scan lines 132₁, 132₂, . . . , 132ₘ, and transmits data of a display image to the pixels of the display panel 110 through the source data lines 122₁, 122₂, . . . , 122₃ₙ, so as to display a corresponding image.

The source driver 120 is disposed at a side L of the display panel 110, and the gate driver 130 is disposed at another side H of the display panel 110, where a length of the side L is generally greater than that of the side H, namely, the number of the source data lines 122₁, 122₂, . . . , 122₃ₙ is greater than the number of the gate scan lines 132₁, 132₂, . . . , 132ₘ, i.e. 3n>m. Since the source driver 120 has to drive the three display spots of each of the pixels 112, and the gate driver 130 controls the pixels of a whole row through the gate scan line, the number of the source data lines 122 is greater than the number of the gate scan lines 132.

Moreover, referring to FIG. 1C, FIG. 1C is a schematic diagram illustrating an assembling structure of the display device 100 of FIG. 1A. The source driver device 120 includes a plurality of source driver unit 102a. The gate driver device 130 includes a plurality of gate driver units 130a. The timing controller 140 of the display device 100 is disposed on a timing control PCB 170, and the timing control PCB 170 includes an input signal connection port 104 for connecting to an external signal source. The timing control PCB 170 is connected to a gate driving board 172 through a signal bus 171, and the gate driving board 172 is configured with the plurality of the gate driver units 130a, where a configuring method thereof is, for example, an electrical connection through flexible printed circuit (FPC) attachment. Moreover, the timing control PCB 170 is electrically connected to a source driving board 174 through the FPC attachment, and the source driving board 174 is configured with the plurality of source driver units 120a.

The structure and the driving method of the conventional display device require a large number of the source data lines, and the power consumed by the source driver for driving the source data lines is far greater than that for driving the gate scan lines. Moreover, the circuit driven by the source driver is complicated, and fabrication cost of integrated circuits (ICs) is high, which leads to a high cost of the display device.

Moreover, as a resolution of the flat panel display device increases, an operating frequency of the display device is increased, and design complexity of the required circuit is accordingly enhanced. As a design of each IC unit is different, a frequency of a timing cycle is increased as the circuit complexity increases, which may lead to a severe electromagnetic interference (EMI). Moreover, to achieve a requirement of carbon reduction, reduction of power consumption is always an important issue under development for the flat panel display device.

### SUMMARY OF THE INVENTION

The invention provides a gate driver having a timing control function and a display device using the gate driver. The display device includes a display panel, at least one source driver and at least one gate driver. The display panel includes a plurality of pixels, and each of the pixels is connected to at least one gate scan line and one source data line. The source driver is connected to the pixels through the source data lines.

The gate driver includes an image data receiving interface, an image processing unit, a timing controller, and a gate driving unit. The image data receiving interface receives an input signal and transfers the input signal into a display image data and a display control signal. The image processing unit receives the display image data and transfers the same into display data. The timing controller receives the display control signal and transfers the same into a first control signal and a second control signal. The first control signal and the display data are output to the source driver. The gate driving unit receives the second control signal to drive the gate scan lines, where the gate driving unit sequentially drives the gate scan lines according to the second control signal, and the source driver supplies the display data to the pixels according to the first control signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a conventional display device.

FIG. 1B is a schematic diagram illustrating a connection structure of a display panel, a source driver, a gate driver and a timing controller of the display device of FIG. 1A.

FIG. 1C is a schematic diagram illustrating an assembling structure of the display device of FIG. 1A.

FIG. 2A is a schematic diagram of a display device according to an embodiment of the invention.

FIG. 2B is a schematic diagram illustrating an assembling structure of the display device of FIG. 2A.

FIG. 3A is a circuit block schematic diagram of a gate driver according to an embodiment of the invention.

FIG. 3B is a circuit block schematic diagram of a gate driving unit in the gate driver of FIG. 3A.

FIG. 3C is a flowchart illustrating a data processing method of a control signal in the gate driver of FIG. 3A.

FIG. 3D is a circuit block schematic diagram of a gate driver according to another embodiment of the invention.

FIGS. 4-1(a), 4-1(b) and 4-1(c) are timing diagrams for a conventional timing controller transmitting control signals and display image data to a source driver.

FIG. 4-2(a) and FIG. 4-2(b) are timing diagrams for a conventional timing controller transmitting control signals to a gate driver.

FIG. 5-1(a) and FIG. 5-1(b) are timing diagrams for a gate driver having a timing control function transmitting control signals and display image data to a source driver according to an embodiment of the invention.

FIGS. 5-1(c), 5-2(a) and 5-2(b) are timing diagrams for a gate driver having a timing control function transmitting pulse signals to gate lines to drive corresponding pixels in a display panel according to an embodiment of the invention.

### DETAILED DESCRIPTION OF DISCLOSED EMBODIMENTS

Since display devices of different sizes have different requirements for used components, different display devices in the market are fabricated with different driving devices and timing controllers. In a design of the driving device, a size thereof relates to the fabrication cost. In a general display device with a large size, since a resolution is increased, integrated circuits (ICs) require more output pins, so that a gate driver IC, a source driver IC and a timing controller IC are respectively fabricated in the display device to avoid signal attenuation due to a long signal transmission distance when a signal is transmitted in the display device, so as to avoid signal error.

In a display device with a small size, since the signal transmission distance is relatively short, and comparatively, the sizes of the ICs and the number of the used devices are more carefully designed, it is still applicable to separate the timing controller IC, the source driver IC, and the gate driver IC, though the number of the ICs and the size thereof are relatively large, which leads to a high cost.

In an embodiment of the invention, a design of integrating a timing control function to a gate driver is disclosed. In another embodiment, the gate driver having the timing control function is disposed at a side of a flat panel display device with longer driving wiring to reduce the number of the used source drivers, so as to reduce the cost.

In an embodiment, regarding the design of integrating the timing control function to the gate driver, the gate driver having the timing control function is referred to as a smart gate driver. The smart driver is disposed at a side of the display device with relatively more driving wiring, which is generally the side with a longer length, and in the display device, the side is determined according to the number of the driving wiring required at the side of the display panel, and is the side requires more driving wiring. In the above structure, since an operating frequency of the gate driver is lower than an operating frequency of the source driver, the number of signal lines required for high-frequency operation is reduced, and meanwhile the problem of electromagnetic interference (EMI) is mitigated.

In an embodiment, according to the design of integrating the timing control function to the gate driver, a driving signal and a synchronous signal required by liquid crystal display are effectively processed, and the two signals are precisely transmitted to the display device having a suitable common voltage V_{COM}, so as to drive the display device to display.

In the invention, according to the design of integrating the timing control function to the gate driver, the fabrication cost is reduced, the EMI problem is mitigated and the power consumption is reduced. Embodiments of the invention are described below with reference of figures.

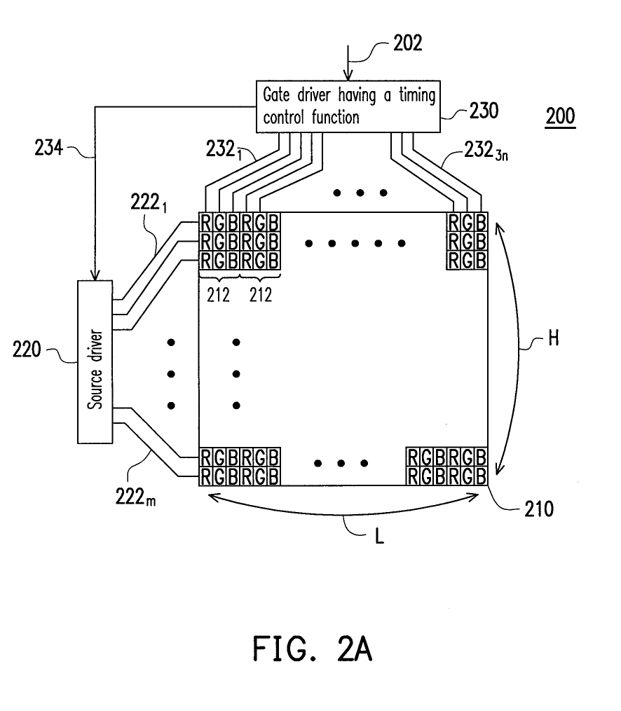

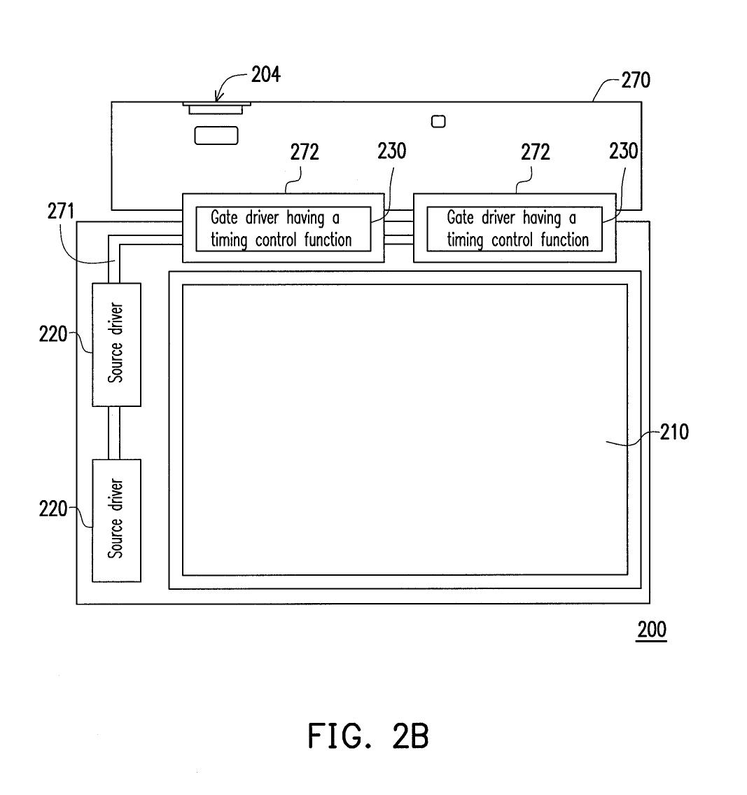

Referring to FIG. 2A, FIG. 2A is a schematic diagram of a display device according to an embodiment of the invention. The display device 200 includes a display panel 210, a source driver 220 and a gate driver 230 having the timing control function. The display panel 210 includes a plurality of pixels 212 arranged in an array, and each of the pixels 212 includes display spots of three primary colors of red (R), green (G) and blue (B), which are respectively corresponded to a source data line 222 of the source driver 220 and a gate scan line 232 of the gate driver 230, and are driven by the source driver 220 and the gate driver 230 having the timing control function to display. Namely, the pixels 212 are controlled through the gate scan lines 232₁, 232₂, . . . , 232₃ₙ, and data of a display image is transmitted to the pixels of the display panel 210 through the source data lines 222₁, 222₂, . . . , 222ₘ, so as to display a corresponding image.

In the display device 200 of the embodiment, the source driver 220 is disposed at a side H, and the gate driver 230 having the timing control function is disposed at another side L, where a length of the side L is greater than that of the side H. 3n gate scan lines 232₁, 232₂, . . . , 232₃ₙ of the gate driver 230 having the timing control function are respectively connected to the display spots of three primary colors of red (R), green (G) and blue (B) from each of the pixels 212, and are used to turn on the display spots. The source driver 220 supplies data of a display image to the pixels through the m source data lines 222₁, 222₂, . . . , 222ₘ, where the number of the gate scan lines 232 is greater than the number of the source data lines 222.

Namely, in case of a same size and a same resolution demand of the display device, the structure of the present embodiment can effectively reduce the number of the required source drivers, so as to effectively reduce the fabrication cost.

Moreover, the gate driver 230 having the timing control function is coupled to the source driver 220 for providing display data and control signals to the source driver 220. The gate driver 230 having the timing control function receives display image data and synchronous signals from external, and maps the display image data, and transfers the display image data into a format that can be accepted by an output interface for outputting to the source driver 220.

Further, according to the structure of the present embodiment, the display data and the required control signals transmitted to the source driver from the gate driver having the timing control function can be transmitted to a plurality of source drivers through a parallel manner. In the structure of the present embodiment, if a plurality of gate drivers is used, the gate drivers may have a master and slave configuration, where one or a part of the gate drivers are taken as master gate drivers, and the other gate drivers are taken as slave gate drivers. The master gate drivers control all of the operations, and the slave gate drivers are turned off. Considering the fabrication cost, the structure provided by the embodiment is preferably to apply two smart gate drivers or a single smart gate driver.

Referring to FIG. 2B, FIG. 2B is a schematic diagram illustrating an assembling structure of the display device 200 of FIG. 2A. As shown in FIG. 2B, a timing control PCB 270 includes an input signal connection port 204 for connecting to an external signal source. Moreover, since the timing control function is built in the gate driver 230, the timing control PCB 270 is unnecessary to be attached with a timing control IC. The timing control PCB 270 is electrically connected to gate driving boards 272 through flexible printed circuit (FPC) attachment, so as to transmit control signals to the gate drivers 230 having the timing control function. The timing control PCB 270 is connected to the source driver 220 through a signal bus 271 on the display panel. In the present embodiment, a plurality of the source drivers 220 is configured, which are, for example, connected in parallel through the signal bus of the display panel.

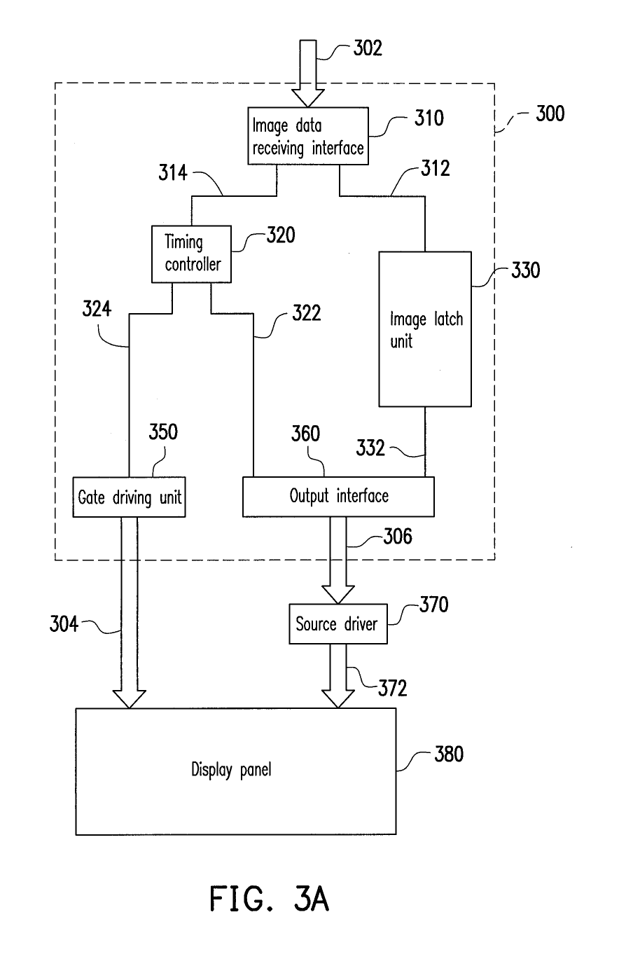

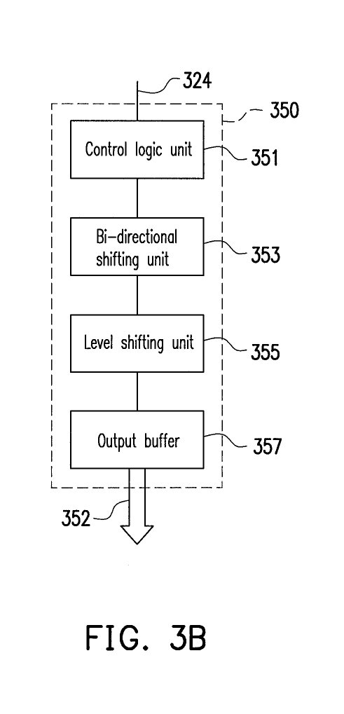

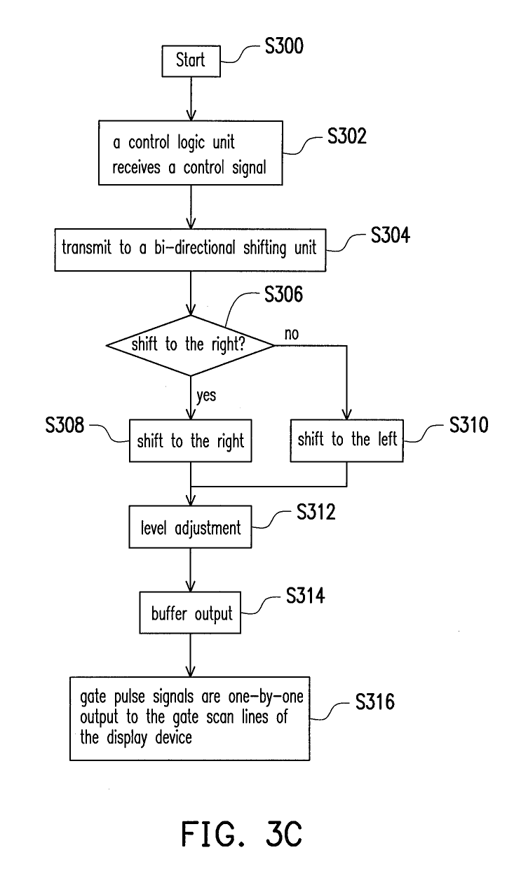

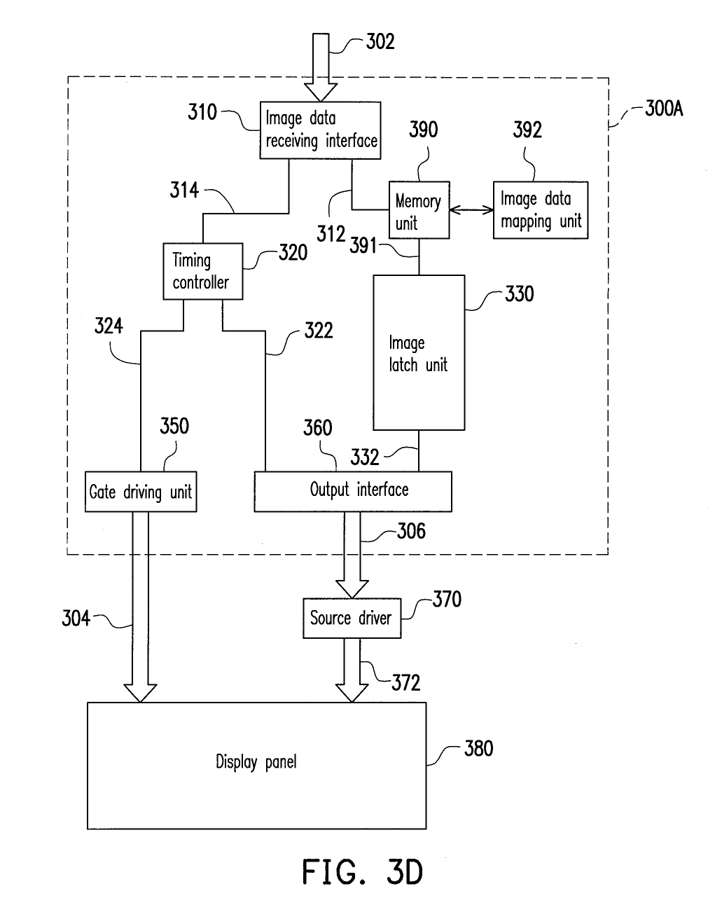

FIG. 3A is a schematic diagram of a display device according to an embodiment of the invention, in which a circuit block diagram of a gate driver having the timing control function is illustrated. The gate driver 300 includes an image data receiving interface 310 for receiving signals through an image data connection line 302. The signals include display image data and display control signals, where the display control signals include a plurality of control information and at least one synchronous signal, etc.

The gate driver 300 is connected to a display panel 380 through gate scan lines 304. Moreover, the gate driver 300 is connected to a source driver 370 through a data and control signal bus 306, and provides the display image data and a first control signal to the source driver 370. In response to control information in the first control signal, the source driver 370 transmits the display image data to the display panel 380 through source data lines 372. The first control signal provided to the source driver 370 includes a vertical data input output start pulse DIO_V, a vertical polarity reversal control signal POL_V, a vertical timing pulse CKH_V (VLK_V), and a load control signal Load used for loading an analog voltage output by the source driver to the display panel.

The gate driver 300 transmits a synchronous timing pulse to the source driver 370 during an enable period of a vertical synchronizing signal, so that the vertical data input output start pulse DIO_V, the vertical polarity reversal control signal POL_V and the vertical timing pulse CKH_V provided to the source driver 370 are different to the conventional control signals. Besides a gate control function for the pixels in the display panel 380, the gate diver 300 further provides the image display data and the control signals to the source driver 370.

In the present embodiment, gate driver 300 having the timing control function includes the image data receiving interface 310, a timing controller 320, an image latch unit 330, a gate driving unit 350 and an output interface 360.

The image data receiving interface 310 receives an input signal and transfers the input signal into the display image data 312 and the display control signal 314. The display image data 312 is transmitted to the image latch unit 330, and is transferred into a data format that can be accepted by the output interface 360, and then it is output to the source driver 370. The display control signal 314 is transmitted to the timing controller 320, where the display control signal 314 includes a horizontal synchronizing signal and a vertical synchronizing signal.

The display image data 312 is first adjusted to be synchronous to the control signal by the image latch unit 330, and then transferred into an arranging manner that can be accepted by the output interface 360. The display data is one-by-one output to the output interface 360 through a signal 332. Then, the display data and the control signal are provided to the source driver 370 through the data and control signal bus 306.

The display control signal 314 is transmitted to the timing controller 320 to generate a first control signal 322 and a second control signal 324, which are respectively transmitted to the source driver 370 and the internal gate driving unit 350, wherein the second control signal 324 includes a horizontal start pulse ST_H, a gate driver output enable signal OE_H and a horizontal clock signal CLK_H.

FIG. 3B is a circuit block schematic diagram of a gate driving unit in the gate driver of FIG. 3A. In the present embodiment, the gate driving unit 350 includes a control logic unit 351, a bi-directional shifting unit 353, a level shifting unit 355 and an output buffer 357.

After the system starts, the control logic unit 351 receives the second control signal 324, and transmits the same to the bi-directional shifting unit 353. Then, the bi-directional shifting unit 353 determines whether an initial side of a scan direction is at the left or the right. The level shifting unit 355 suitably adjust a level of the control signal, and the output buffer 357 outputs the control signal to the display panel.

A data processing flow of the control signal 324 of the gate driver is as that shown in FIG. 3C, in which after the display device powers on, the gate driver starts to process signals (S300). When the control signal is transmitted to the gate driving unit 350 from the timing controller 320, the control logic unit 351 receives the control signal and performs control logic processing (step S302). Then, the bi-directional shifting unit 353 determines a shifting direction (step S306). If the shifting direction is determined to be rightwards, the bi-directional shifting unit 353 outputs a right-shifted signal (step S308). Comparatively, in step S310, the bi-directional shifting unit 353 outputs a left-shifted signal to obtain a sequential scan signal for outputting to the level shifting unit 355. The level shifting unit 355 performs level adjustment (step S312), and transfers a voltage level of the sequential scan signal into a voltage required by the display device, so as to output a scan signal. The output buffer 357 receives and buffers the scan signal, and sequentially outputs the level-shifted scan signal (step S314). Finally, gate pulse signals are one-by-one output to the gate scan lines of the display device for transmitting to the display panel (step S316).

FIG. 3D is a schematic diagram of a display device according to another embodiment of the invention. The same parts between the gate driver 300A and the gate driver 300 are indicated by the same referential numbers, and different parts there between are described below. The gate driver 300A having the timing control function also includes the image data receiving interface 310, the timing controller 320, the image latch unit 330, the gate driving unit 350 and the output interface 360. Besides, the gate driver 300A having the timing control function further includes a memory unit 390 and an image data mapping unit 392 connected to the memory unit 390.

In an embodiment, the display image data 312 received by the image data receiving interface 310 can be transmitted to the source driver 370 without being transferred, as that shown in FIG. 3A. However, in another embodiment, the received display image data 312 is not suitable in the requirement of format, so that the display image data 312 is further transferred. For example, when an image data mapping transfer is required to be added to match the data format of the gate driver 300A having the timing control function, mapping transfer of the received display image data 312 has to be first performed. In an embodiment, the received display image data 312 is transmitted to the image data mapping unit 392 from the memory unit 390 for mapping processing, and then mapped display image data 391 is transmitted to the image latch unit 330.

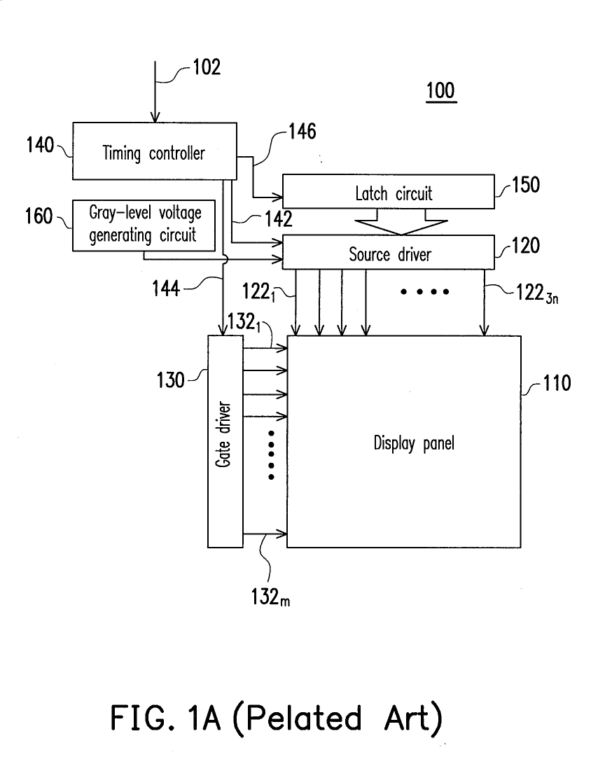

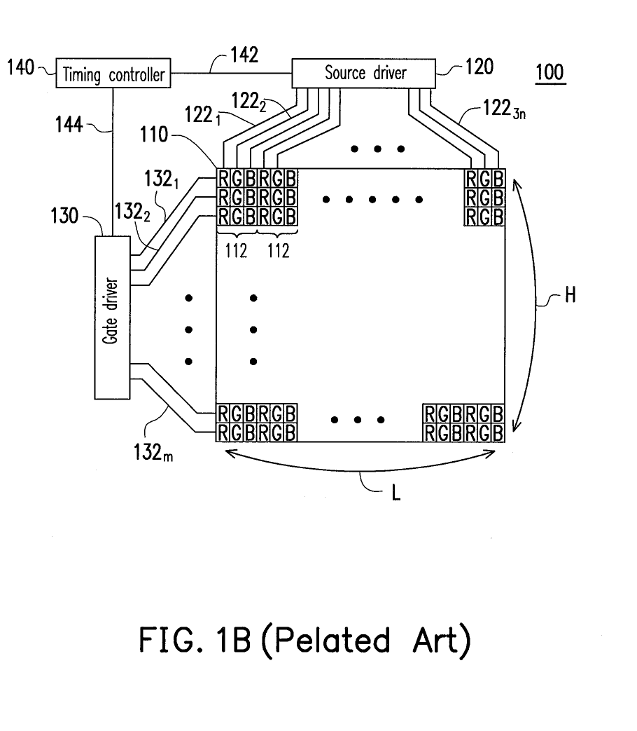

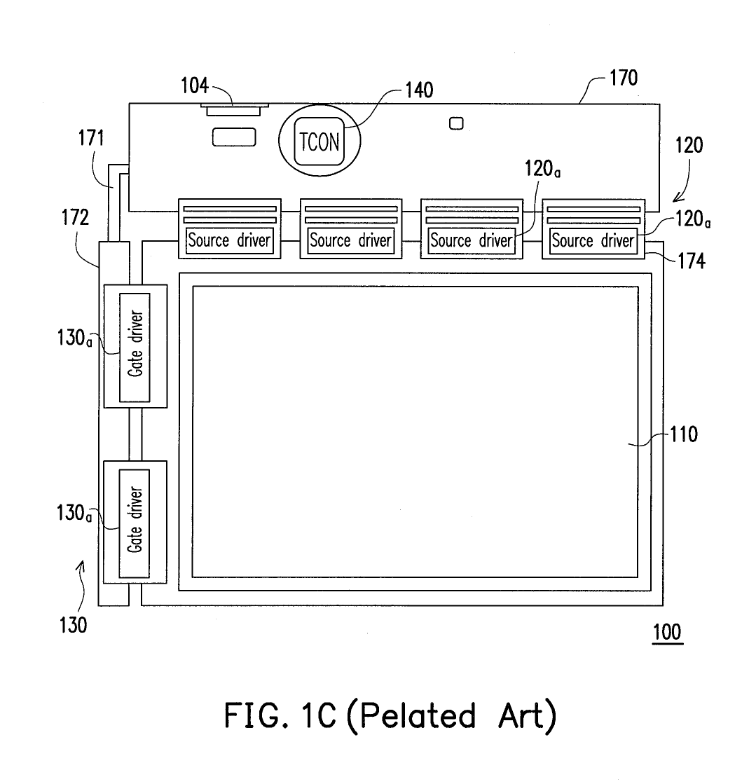

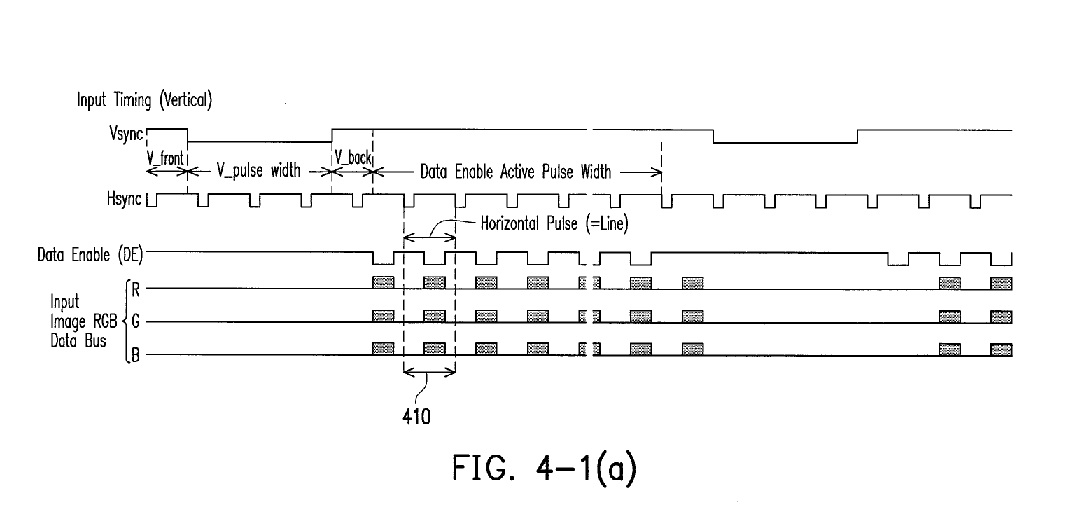

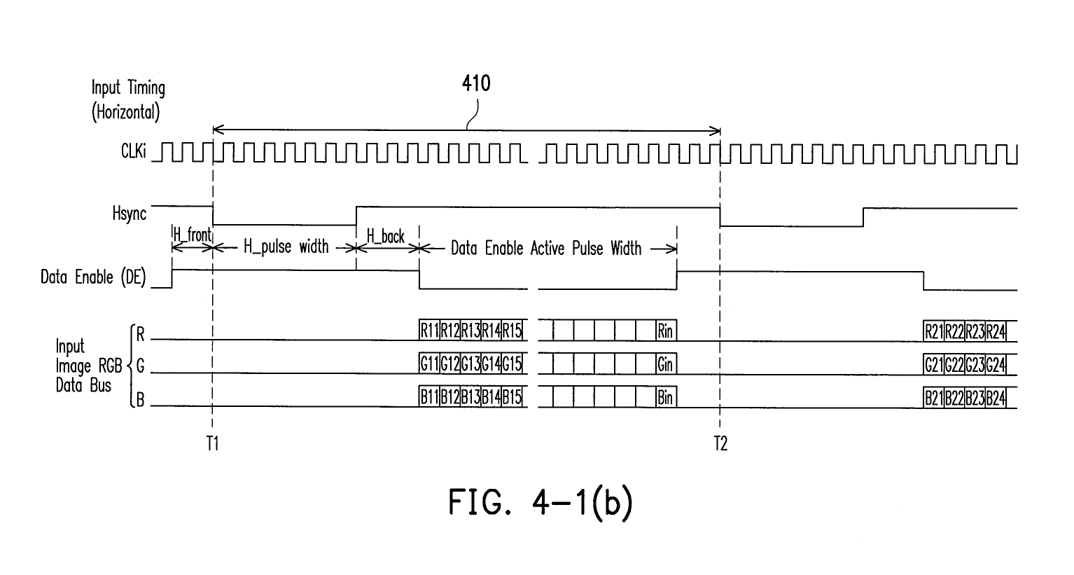

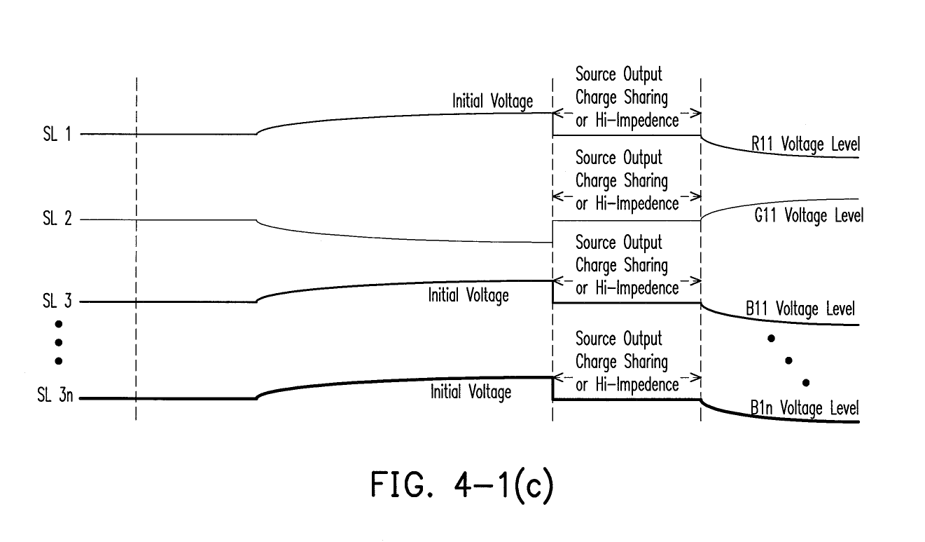

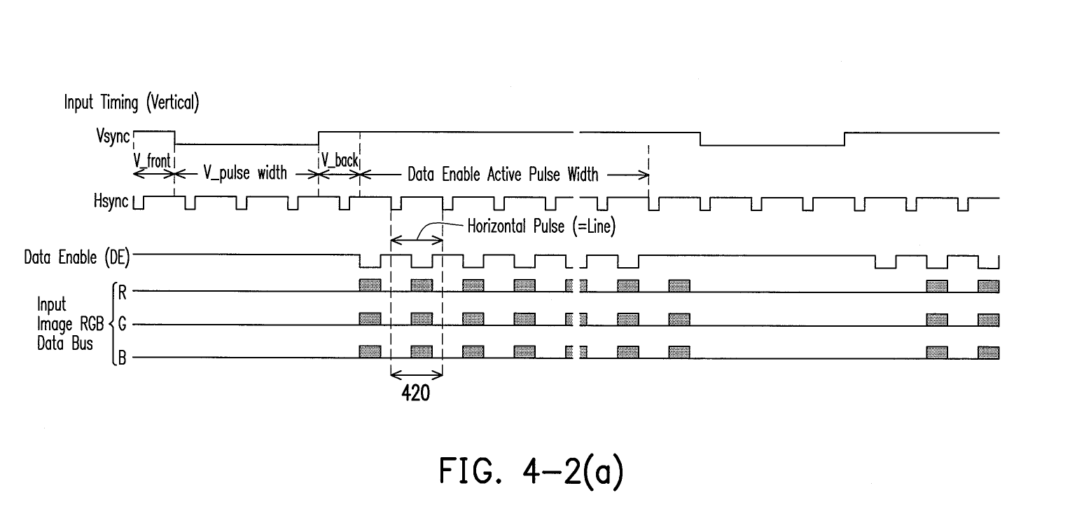

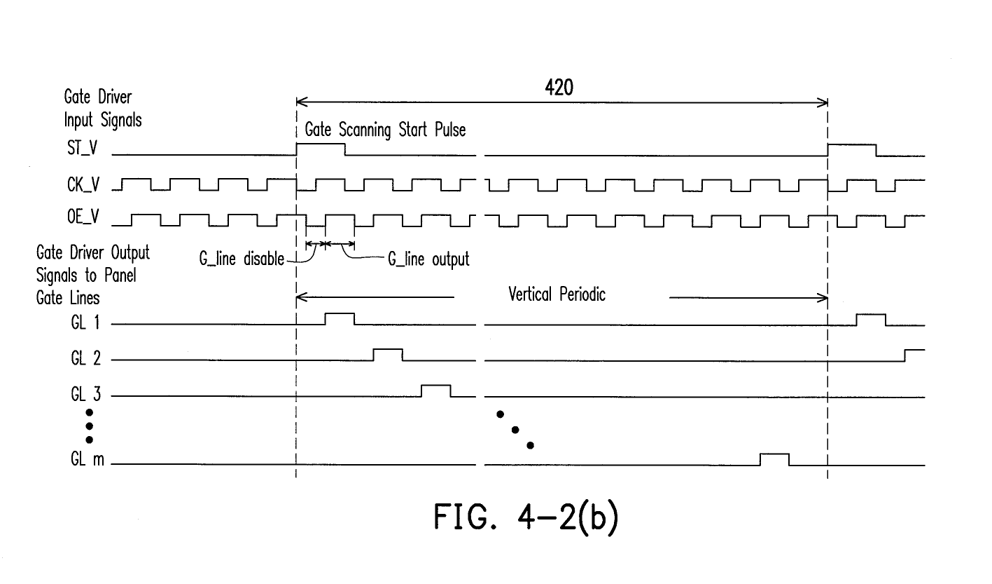

FIGS. 4-1(a)˜(c) and 4-2(a)(b) are timing diagrams for a conventional timing controller transmitting control signals and display image data to a source driver. In FIG. 4-1(a), when a horizontal synchronizing signal Hsync and a horizontal clock signal CLKi are received. The source driver starts to transmit the display data to the corresponding data lines on the display panel according to the received control signal during a data transmission period. According to a frequency of the horizontal clock signal CLKi, the input image RGB data is received during a data enable active pulse width period after data enable (a DE clock shown in FIG. 4-1(a)) is performed. Display data is provided to the display spots of three primary colors of red (R), green (G) and blue (B) of the first row pixels on the display panel, for example, display data B11, B12, . . . , B1n are provided to the blue (B) display spots, display data G11, G12, . . . , G1n are provided to the green (G) display spots, and display data R11, R12, . . . , R1n are provided to the red (R) display spots. In each subsequent horizontal period, display data from each row of the pixels are sequentially received. In FIG. 4-1(c), the display data from each row of the pixels are successively received, and the source driver sequentially transmits the display data to the pixels on the corresponding data lines of the display panel.

FIG. 4-2(a) and FIG. 4-2(b) are timing diagrams for a conventional timing controller transmitting control signals to a gate driver. According to the pulses of the vertical synchronizing signal, a data transmission period is entered, which is, for example, a data enable active pulse width period. Now, the gate driver receives a vertical start pulse ST_V, a gate driver output enable signal OE_V and a vertical clock signal CLK_V. When the gate driver output enable signal OE_V has a logic low level, the gate driver does not, provide signals to the gate lines. Otherwise, when the gate driver output enable signal OE_V has a logic high level, the gate driver outputs the control signals to the corresponding gate lines. The pulse signals are successively transmitted to the gate lines to drive the corresponding pixels in the display panel, for example, the gate lines GL1, GL2, GL3, . . . , GLm in FIG. 4-3.

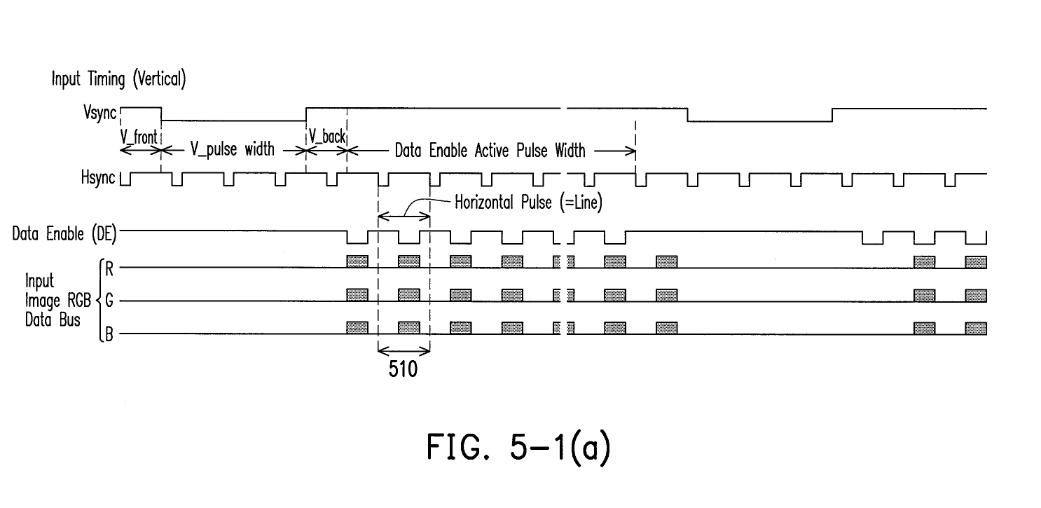

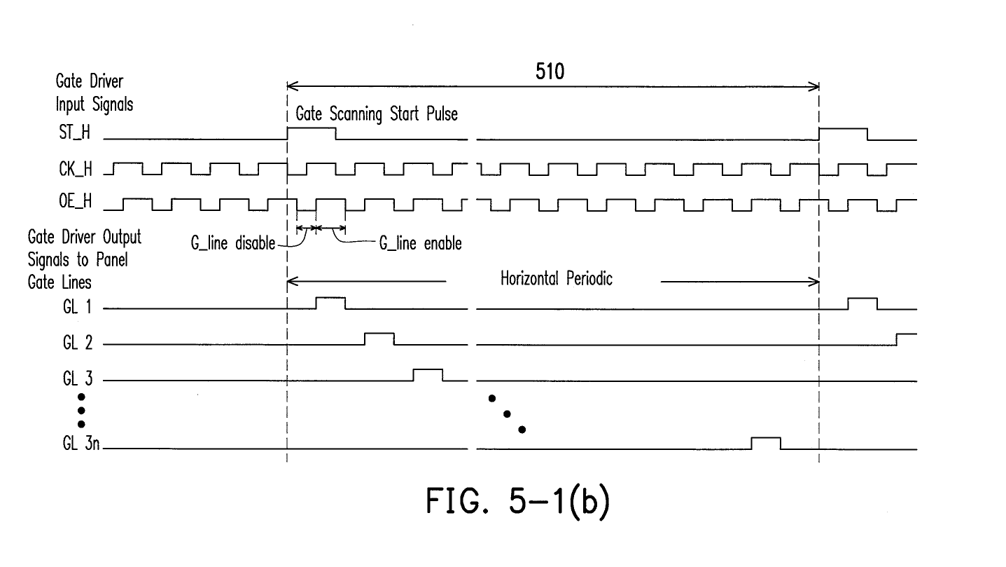

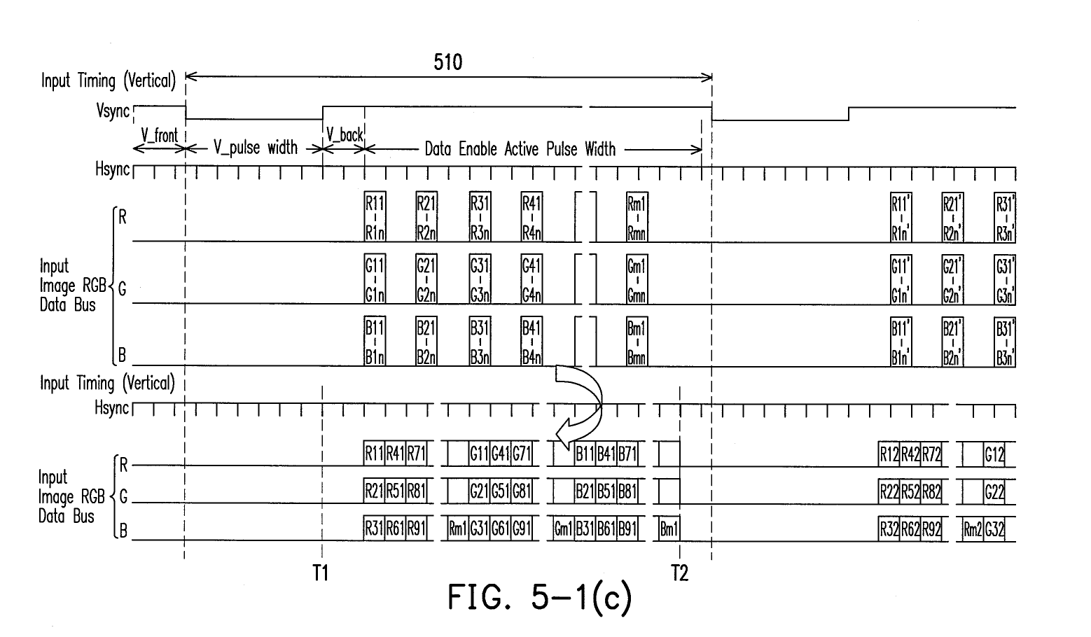

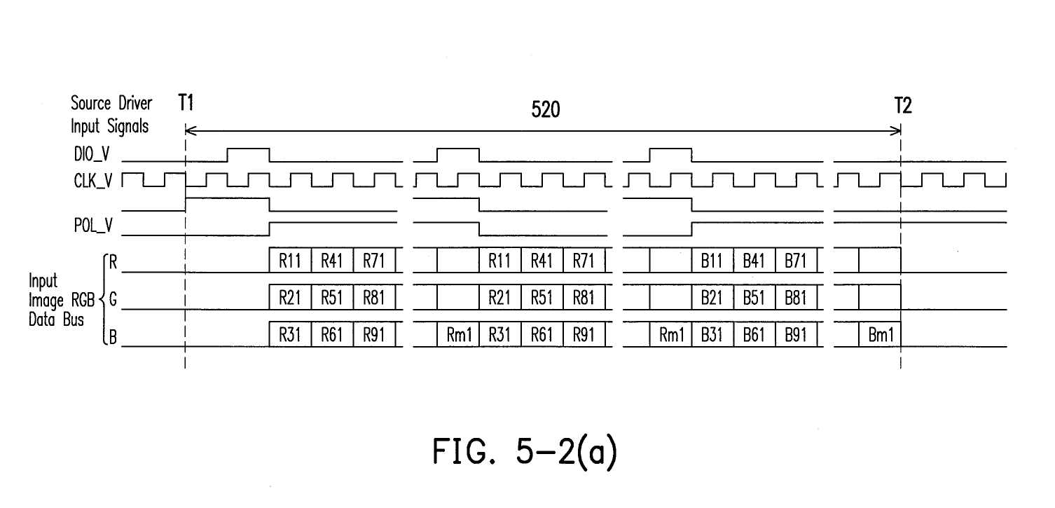

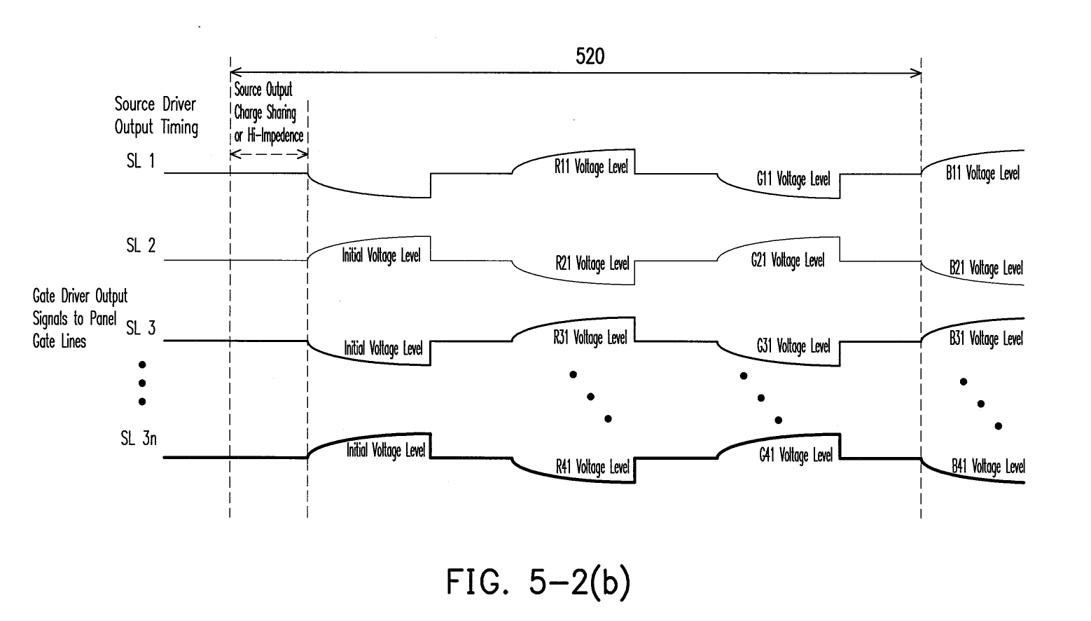

Different to the conventional structure, the controls signals transmitted to the gate lines by the gate driver having the timing control function are sequentially sent according to the vertical synchronizing signal Vsync and the vertical clock signal CLK_V, as that shown in FIG. 5-1(a)˜FIG. 5-2(b). The synchronous timing pulses transmitted to the source driver by the gate driver having the timing control function are transmitted during an enable period of the vertical synchronizing signal Vsync. Therefore, the control signals provided to the source driver include the vertical data input output start pulse DIO_V, the vertical polarity reversal control signal POL_V, and the vertical timing pulse CKH_V, which are different to the conventional control signals, as shown in FIG. 5-1(c), 5-2(a) and 5-2(b).

Referring to FIG. 5-1(a)˜FIG. 5-2(b), during the enable period of the vertical synchronizing signal Vsync, a data transmission period is entered, which is, for example, a data enable active pulse width period. During each of the horizontal periods, the gate driver receives a horizontal start pulse ST_H, a gate driver output enable signal OE_H and a horizontal clock signal CLK_H. When the gate driver output enable signal OE_H has a logic low level, the gate driver does not provide signals to the gate lines. Otherwise, when the gate driver output enable signal OE_H has a logic high level, the gate driver outputs the control signals to the corresponding gate lines. The pulse signals are successively transmitted to the gate lines to drive the corresponding pixels in the display panel, for example, the gate lines GL1, GL2, GL3, . . . , GL3n in FIG. FIG. 5-1(a)˜FIG. 5-2(b).

In the display device provided by the invention, the source driver is disposed at the side H, and the gate driver having the timing control function is disposed at the other side L, where a length of the side L is greater than a length of the side H. 3n gate scan lines of the gate driver having the timing control function are respectively connected to the display spots of three primary colors of red (R), green (G) and blue (B) of the pixels, and are used to turn on the display spots. The source driver supplies data of the display image to the pixels through m source data lines, where the number of the gate scan lines is greater than the number of the source data lines.

Referring to FIGS. 5-1(c), 5-2(a) and 5-2(b), the synchronous timing pulses transmitted to the source driver by the gate driver having the timing control function are transmitted during the enable period of the vertical synchronizing signal Vsync, so that during the data enable active pulse width period of the vertical synchronizing signal, the input image RGB data is received from external. The display data is provided to the first row to m^{th} row of the pixels on the display panel. For example, the display data provided to the first row of the pixels includes B11, B12, . . . , B1n of the blue (B) display spots, G11, G12, . . . , G1n of the green (G) display spots and R11, R12, . . . , R1n of the red (R) display spots. Also, the display data provided to the m^{th} row of the pixels includes Bm1, Bm2, Bmn of the blue (B) display spots, Gm1, Gm2, Gmn of the green (G) display spots and Rm1, Rm2, Rmn of the red (R) display spots.

In the gate driver having the timing control function, if the received display image data is complied with a predetermined format, data transfer is not performed, otherwise if the display image data that is not complied with the predetermined format, an image data mapping transfer is required to be performed, as shown in FIG. 5-1(c).

As shown in FIG. 5-1(c), the received display image data is display data to be provided to each row of the pixels, which includes the display data R11-R1n, R21-R2n, Rm1-Rmn of the red (R) display spots, the display data B11-B1n, B21-B2n, Bm1-Bmn of the blue (B) display spots, and the display data G11-G1n, G21-G2n, Gm1-Gmn of the green (G) display spots. Since the received display image data is required to be transferred, the received display image data is transferred to be as that shown in the lower part of FIG. 5-1(c) through data mapping, by which the display data R11-R1n, R21-R2n, Rm1-Rmn are transferred to a first set R11, R21, R31, a second set R41, R51, R61, . . . , till Rm1 that are respectively arranged by the

RGB data bus, which are only the display data of the first row of the pixels. After the display data R11, R21, R31, . . . , Rm1 of the red (R) display spots of the first row of the pixels are transmitted, the display data of the green (G) display spots of the first row of the pixels are then transmitted.

Similarly, the display data G11-G1n, G21-G2n, . . . , Gm1-Gmn are transferred to a first set G11, G21, G31, a second set G41, G51, G61, . . . , till Gm1 that are respectively arranged by the RGB data bus, which are only the display data of the first row of the pixels. Then, the display data of the blue (B) display spots of the first row of the pixels are transmitted. Similarly, the display data B11-B1n, B21-B2n, . . . , Bm1-Bmn are transferred to a first set B11, B21, B31, a second set B41, B51, B61, . . . , till Bm1 that are respectively arranged by the RGB data bus, which are only the display data of the first row of the pixels.

Between the time points T1 and T2, the source driver sequentially transmits the display data to the pixels on the corresponding data lines of the display panel according to the received control signals, including the vertical data input output start pulse DIO_V, the vertical polarity reversal control signal POL_V, and the vertical timing pulse CKH_V.

Based on aforementioned data mapping transfer and transmission of the RGB data bus, the first row to final row of the data are sequentially transmitted. Besides the timing control function, the gate driver of the embodiment also receives the image data to be displayed, and transfers the same if necessary, and then transmits the display image data and the control signal to the source driver for display.

As shown in FIGS. 5-2(a) and 5-2(b), the synchronous timing pulses transmitted to the source driver by the gate driver having the timing control function are transmitted during the enable period of the vertical synchronizing signal Vsync, so that the control signals provided to the source driver includes the vertical data input output start pulse DIO_V, the vertical polarity reversal control signal POL_V, and the vertical timing pulse CKH_V.

Regarding the data received from the RGB data bus, taking the first row of display data as an example. The first row of display data of the red (R) display spots includes B11, B21, B31, B41, B51, B61, . . . , Bm1, which are respectively transmitted to the display panel through data lines SL1, SL2, SL3, . . . , SLm of the source driver. Then, the first row of display data of the green (G) display spots includes G11, G21, G31, G41, G51, G61, . . . , Gm1, and the first row of display data of the blue (B) display spots includes B11, B21, B31, B41, B51, B61, . . . , Bm1, which are sequentially transmitted to the display panel through the data lines SL1, SL2, SL3, . . . , SLm of the source driver.

In summary, owing to complexity of the internal circuit of the source driver is higher than that of the gate driver, and the number of required devices of the source driver is greater than that of the gate driver, if the number of the source drivers is increased, the cost of the display device is greatly increased. According to the structure design of the invention, the source driver is disposed at the side H of the display panel with relatively less scan lines, and the gate driver is disposed at the side L of the display panel with relatively mores scan lines, so as to achieve a low cost compared to that of the conventional structure.

Moreover, since the gate driver has a low cost compared to that of the source driver, and the operating frequency of the gate driver is far less than that of the source driver, the EMI problem is greatly mitigated. Besides, the power consumed by the gate driver is far less than that of the source driver, so that the whole system power is greatly decreased, which meets the needs of environmental protection and energy saving products. In such structure, not only the numbers of ICs and internal required devices are reduced, but also a circuit board wiring configuration of the whole display device is simplified, which avails designing a middle and small size display device and reducing the fabrication cost.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A gate driver, adapted to a display panel, the gate driver comprising:
an image data receiving interface, for receiving an input signal, and generating a display image data and a display control signal according to the input data;
an image latch unit, for generating a display data according to the display image data;
a timing controller, for receiving the display control signal and generating a first control signal and a second control signal, the timing controller outputs the first control signal and the display data to a source driver during an enable period of a vertical synchronizing signal, wherein the source driver is disposed at a first side of the display panel; and
a gate driving unit, disposed at a second side of the display panel, for receiving the second control signal to drive a plurality of gate scan lines, wherein the second side is greater than the first side.

2. The gate driver as claimed in claim 1, wherein the display panel comprises a plurality of pixels respectively corresponding to one of the plurality of gate scan lines and one of a plurality of source data lines, and the source driver outputs the display data to the pixels through the source data lines according to the first control signal.

3. The gate driver as claimed in claim 1, wherein the first control signal comprises a vertical data input output start pulse, a vertical polarity reversal control signal and a vertical timing pulse.

4. The gate driver as claimed in claim 1, wherein the vertical timing pulse is transmitted during the enable period of the vertical synchronizing signal, and during an enable period of the vertical timing pulse, the source driver receiving the display data.

5. The gate driver as claimed in claim 1, wherein the gate driving unit comprises:
a control logic unit, for outputting a signal according to the second control signal;
a bi-directional shifting unit, for receiving the signal and determining a scan direction;
a level shifting unit, for adjusting a voltage level of the signal according to the scan direction, so as to output a scan signal; and
an output buffer, for receiving the scan signal of the level shifting unit, and sequentially outputting the scan signal, so as to drive the gate scan lines.

6. The gate driver as claimed in claim 1, wherein the second control signal comprises a horizontal start pulse, a gate driver output enable signal and a horizontal clock signal.

7. The gate driver as claimed in claim 6, wherein
during a data enable active pulse width period, the gate driving unit receiving the horizontal start pulse, the gate driver output enable signal and the horizontal clock signal of the second control signal, and
wherein the gate driving unit stops providing pulse signals to the plurality of gate scan lines during a period when a data enable signal is in a state of logic low, and the gate driving unit providing pulse signals to the plurality of gate scan lines for driving corresponding pixels in the display panel during another period when the data enable signal is in a state of logic high.

8. The gate driver as claimed in claim 1, further comprising an output interface for receiving the display data and the first control signal, and outputting the same to the source driver.

9. The gate driver as claimed in claim 1, wherein between the image data receiving interface and the image latch unit, the gate driver further comprises:
a memory unit, connected to the image data receiving interface, for temporarily storing the display image data; and
an image data mapping unit, connected to the memory unit, for reading the display image data temporarily stored in the memory unit, and transferring the same into a mapped display image data in order to output to the image latch unit, wherein the image latch unit generates the display data according to the mapped display image data.

10. A display device, having a display panel, wherein the display panel comprises a plurality of pixels respectively connected to one of a plurality of gate scan lines and one of a plurality of source data lines correspondingly, the display device comprising:
a source driver, disposed at a first side of the display panel, and respectively connected to the plurality of pixels through the source data lines; and
a gate driver, disposed at a second side of the display panel, wherein the second side is greater than the first side, and the gate driver comprises:
an image data receiving interface, for generating a display image data and a display control signal according to the input signal;
an image latch unit, for generating display data according to the display image data;
a timing controller, for receiving the display control signal and generating a first control signal and a second control signal, and outputting the first control signal and the display data to the source driver during an enable period of a vertical synchronizing signal, wherein the source driver outputs the display data to the pixels according to the first control signal; and
a gate driving unit, for receiving the second control signal to sequentially drive the gate scan lines.

11. The display device as claimed in claim 10, wherein the first control signal comprises a vertical data input output start pulse, a vertical polarity reversal control signal and a vertical timing pulse.

12. The display device as claimed in claim 11, wherein the vertical timing pulse is transmitted during the enable period of the vertical synchronizing signal, and during an enable period of the vertical timing pulse, the source driver receiving the display data.

13. The display device as claimed in claim 10, wherein the gate driving unit comprises:
a control logic unit, for receiving the second control signal transmitted by the timing controller and outputting a signal according to the second control signal;
a bi-directional shifting unit, connected to the control logic unit, for determining a scan direction according to the signal;
a level shifting unit, for adjusting a voltage level of the signal according to the scan direction, so as to output a scan signal; and
an output buffer, for receiving the scan signal, and sequentially outputting the scan signal, so as to drive the gate scan lines.

14. The display device as claimed in claim 10, wherein the second control signal comprises a horizontal start pulse, a gate driver output enable signal and a horizontal clock signal.

15. The display device as claimed in claim 14, wherein
during a data enable active pulse width period, the gate driving unit receiving the horizontal start pulse, the gate driver output enable signal and the horizontal clock signal of the second control signal, and
wherein the gate driving unit stops providing pulse signals to the plurality of gate scan lines during a period when a data enable signal is in a state of logic low, and the gate driving unit providing pulse signals to the plurality of gate scan lines for driving corresponding pixels in the display panel during another period when the data enable signal is in a state of logic high.

16. The display device as claimed in claim 10, wherein the gate driver further comprises an output interface for receiving the display data and the first control signal, and outputting the same to the source driver.

17. The display device as claimed in claim 10, wherein between the image data receiving interface and the image latch unit, the display device further comprises:
a memory unit, connected to the image data receiving interface, for temporarily storing the display image data; and
an image data mapping unit, connected to the memory unit, for transferring the display image data temporarily stored in the memory unit into a mapped display image data to output to the image latch unit, wherein the image latch unit generates the display data according to the mapped display image data.
